(19) United States
(12) Patent Application Publication
(10) Pub. No.: US 2026/0149211 A1
(43) Pub. Date: May 28, 2026

(54) VARIABLE-IMPEDANCE CONNECTOR

(71) Applicant: Luxshare precision accessory (Suzhou) LTD., Suzhou City (CN)

(72) Inventors: Dabo LI, Suzhou City (CN); Shengxun QIN, Suzhou City (CN); Hongwei SUN, Suzhou City (CN); Fan XIAO, Suzhou City (CN); Chunhe SHI, Suzhou City (CN)

(73) Assignee: Luxshare precision accessory (Suzhou) LTD., Suzhou City (CN)

(21) Appl. No.: 19/377,425

(22) Filed: Nov. 3, 2025

(30) Foreign Application Priority Data
Nov. 22, 2024 (CN) 202411686677.5

(51) Int. Cl. H01R 13/24; H01R 13/422; H01R 13/504

(52) U.S. Cl. CPC H01R 13/2492; H01R 13/2421; H01R 13/4223; H01R 13/504

(57) ABSTRACT

Provided is a variable-impedance connector. In the variable-impedance connector, a support member is prepared from an insulating material; a fixed conductive assembly is fixed on the support member and has a first fixed conductive portion, a second fixed conductive portion, and a third fixed conductive portion; a movable conductive member is disposed on the support member, is at least partially capable of moving between the first fixed conductive portion and the second fixed conductive portion, and is capable of being connected to and conductive with the first fixed conductive portion or the second fixed conductive portion; the movable conductive member is always connected to and conductive with the third fixed conductive portion in the process of moving between the first fixed conductive portion and the second fixed conductive portion.

### CROSS-REFERENCE TO RELATED APPLICATION

The present application claims priority to Chinese Patent Application No. 202411686677.5, filed with the China National Intellectual Property Administration (CNIPA) on Nov. 22, 2024, the disclosure of which is incorporated herein by reference in its entirety.

### TECHNICAL FIELD

The present disclosure relates to the field of connectors and, in particular, to a variable-impedance connector.

### BACKGROUND

A connector is often used in the field of weak power control. The connector is connected in series in a control circuit. The connector includes a movable contact and two fixed contacts. The movable contact is in contact with one of the fixed contacts in an initial state, and the movable contact is in contact with the other fixed contact in a triggering state. When the movable contact and the two fixed contacts are in contact separately, the signals generated are different. After receiving different contact signals, the controller controls an actuator to perform different actions.

### SUMMARY

The present disclosure adopts the following solutions.

A variable-impedance connector is provided and includes a support member, a fixed conductive assembly, and a movable conductive member.

The support member is prepared from an insulating material.

The fixed conductive assembly is fixed on the support member and has a first fixed conductive portion, a second fixed conductive portion, and a third fixed conductive portion.

The movable conductive member is disposed on the support member. The movable conductive member is at least partially capable of moving between the first fixed conductive portion and the second fixed conductive portion and is capable of being connected to and conductive with the first fixed conductive portion or the second fixed conductive portion. The movable conductive member is always connected to and conductive with the third fixed conductive portion in the process of moving between the first fixed conductive portion and the second fixed conductive portion.

The contact area between the movable conductive member and the first fixed conductive portion is a first area, the contact area between the movable conductive member and the second fixed conductive portion is a second area, the contact area between the movable conductive member and the third fixed conductive portion is a third area, and the third area is smaller than the first area and smaller than the second area.

As an optional solution of the variable-impedance connector, the fixed conductive assembly includes a first conductive member, the first fixed conductive portion is disposed on the first conductive member, the movable conductive member has a movable body and a first movable conductive portion disposed on the movable body, and the movable body is movably disposed on the support member. When the movable conductive member abuts against the first conductive member, the first movable conductive portion abuts against and is conductive with the first fixed conductive portion.

As an optional solution of the variable-impedance connector, the first conductive member is a block structure, the top surface of the first conductive member forms the first fixed conductive portion, the movable body is a cylinder-shaped structure, the lower end surface of the movable body partially protrudes downward to form an elongated conductive arm, and the lower end surface of the conductive arm forms the first movable conductive portion; and/or the support member is wrapped around the outer periphery of the first conductive member by an injection molding process, the first conductive member is a cylindrical structure, and the first conductive member has a stop arm extending in a direction away from the axis of the first conductive member on the circumference of the first conductive member to stop the first conductive member from rotating relative to the support member.

As an optional solution of the variable-impedance connector, the fixed conductive assembly further includes a second conductive member conductively connected to the first conductive member, the third fixed conductive portion is disposed on the second conductive member, the movable conductive member has a third movable conductive portion, and the contact area between the third movable conductive portion and the third fixed conductive portion is the third area.

As an optional solution of the variable-impedance connector, the third movable conductive portion slidingly fits with the third fixed conductive portion.

As an optional solution of the variable-impedance connector, the second conductive member has a second conductive body and a conductive elastic portion disposed on the second conductive body, and the third fixed conductive portion is disposed on the conductive elastic portion and is subjected to an elastic force of the conductive elastic portion to keep a tendency to move toward the third movable conductive portion.

As an optional solution of the variable-impedance connector, the conductive elastic portion includes an elastic arm and an elastic seat, one end of the elastic arm is connected to the second conductive body, the other end of the elastic arm is connected to the elastic seat, a boss protruding toward the third movable conductive portion is formed through the stamped piece-shaped elastic seat, and a sidewall of the boss facing the third movable conductive portion forms the third fixed conductive portion.

As an optional solution of the variable-impedance connector, the movable body is a cylinder-shaped structure, the lower end surface of the movable body partially protrudes downward to form an elongated conductive arm, and the movable body and the outer sidewall of the conductive arm form the third movable conductive portion.

As an optional solution of the variable-impedance connector, the second fixed conductive portion is disposed on the second conductive member, and the movable conductive member has a second movable conductive portion. When the movable conductive member is in a state of being away from the first conductive member, the second fixed conductive portion is connected to and conductive with the second movable conductive portion.

As an optional solution of the variable-impedance connector, the second conductive body is a sheet-shaped structure, the bottom surface of the second conductive body forms the second fixed conductive portion, the movable conductive member includes a cylinder-shaped movable body, the lower end surface of the movable body is partially folded outward to form a limit arm, and the upper side surface of the limit arm forms the second movable conductive portion. The limit arm abuts against the second conductive body when the movable conductive member is in a state of being away from the first conductive member.

As an optional solution of the variable-impedance connector, the second conductive member includes a second conductive body and a conductive connecting sheet disposed on the second conductive body, the first conductive member is a block structure, and the top surface of the first conductive member is welded to the conductive connecting sheet.

As an optional solution of the variable-impedance connector, the second conductive member has at least four conductive connecting sheets. The four conductive connecting sheets are dispersed on the circumferential side of the second conductive body.

As an optional solution of the variable-impedance connector, the second conductive member is detachably connected to the support member.

As an optional solution of the variable-impedance connector, the support member is provided with a slot, the second conductive member further includes a snap-in sheet disposed on the second conductive body, and the snap-in sheet is snapped in the slot.

As an optional solution of the variable-impedance connector, the movable conductive member is subjected to an elastic force to enable the movable conductive member to be at least partially away from the first fixed conductive portion.

As an optional solution of the variable-impedance connector, the variable-impedance connector includes an elastic member. The elastic member is disposed between the support member and the movable conductive member and is used for driving the movable conductive member away from the first fixed conductive portion.

As an optional solution of the variable-impedance connector, the support member includes a support seat and a guide ring, the movable conductive member includes a cylinder-shaped movable body and a blocking plate disposed on one end of the movable body, the guide ring is located in the movable body, the elastic member is a spring, a portion of the spring is located in the guide ring, one end of the spring abuts against the support seat, and the other end of the spring abuts against the blocking plate.

As an optional solution of the variable-impedance connector, the blocking plate is hemispherical and protrudes in a direction away from the movable body.

### BRIEF DESCRIPTION OF DRAWINGS

FIG. 1 is a structure view of a variable-impedance connector at a first viewing angle according to an embodiment of the present disclosure;

FIG. 2 is a structure view of a variable-impedance connector at a second viewing angle according to an embodiment of the present disclosure;

FIG. 3 is a section view taken along A-A in FIG. 2;

FIG. 4 is an enlarged view of the part at J in FIG. 3;

FIG. 5 is a section view taken along B-B in FIG. 2; and

FIG. 6 is an exploded view of a first conductive member, a second conductive member, and a movable conductive member according to an embodiment of the present disclosure.

### DETAILED DESCRIPTION

The solutions of the present disclosure are described clearly and completely hereinafter in conjunction with drawings. Apparently, the described embodiments are part, not all, of embodiments of the present disclosure. Based on the embodiments described herein, all other embodiments obtained by those of ordinary skill in the art on the premise that no creative work is done are within the scope of the present disclosure.

In the description of the present disclosure, it is to be noted that orientations or position relations indicated by terms such as “center”, “upper”, “lower”, “left”, “right”, “vertical”, “horizontal”, “in”, and “out” are based on the drawings. These orientations or position relations are intended only to facilitate and simplify the description of the present disclosure and not to indicate or imply that a device or element referred to must have such particular orientations or must be configured or operated in such particular orientations. Thus, these orientations or position relations are not to be construed as limiting the present disclosure. In addition, terms such as “first” and “second” are used only for the purpose of description and are not to be construed as indicating or implying relative importance. Terms “first position” and “second position” are two different positions. Moreover, when a first feature is described as “on”, “above” or “over” a second feature, the first feature is right on, above or over the second feature, the first feature is obliquely on, above or over the second feature, or the first feature is simply at a higher level than the second feature. When the first feature is described as “under”, “below” or “underneath” the second feature, the first feature is right under, below, or underneath the second feature, the first feature is obliquely under, below or underneath the second feature, or the first feature is simply at a lower level than the second feature.

In the description of the present disclosure, it is to be noted that unless otherwise expressly specified and limited, the term “mounted”, “connected to each other”, or “connected” should be construed in a broad sense, for example, as securely connected, detachably connected, or integrally connected; mechanically connected or electrically connected; directly connected to each other or indirectly connected to each other via an intermediary; or interconnected between two components. For those of ordinary skill in the art, specific meanings of the preceding terms in the present disclosure may be construed based on specific situations.

The embodiments of the present disclosure are described in detail below. Examples of the embodiments are shown in the drawings, where the same or similar reference numerals indicate the same or similar elements or elements having the same or similar functions. The embodiments described below with reference to the drawings are illustrative, intended to explain the present disclosure, and not to be construed as limiting the present disclosure.

For the connector of the related art, when the movable contact moves between the two fixed contacts, the connector is in an open circuit state. However, when the connector is damaged, the connector is also in an open circuit state, and thus, the maintenance personnel cannot be informed in time that the connector has been damaged, thereby affecting the maintenance efficiency and the use experience.

Therefore, a safe and durable variable-impedance connector is needed to solve the above problems.

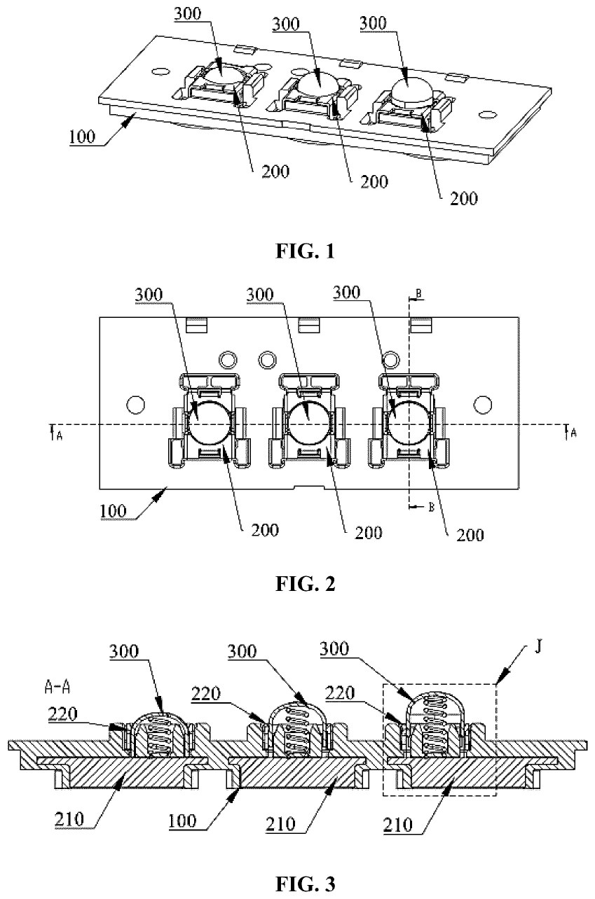

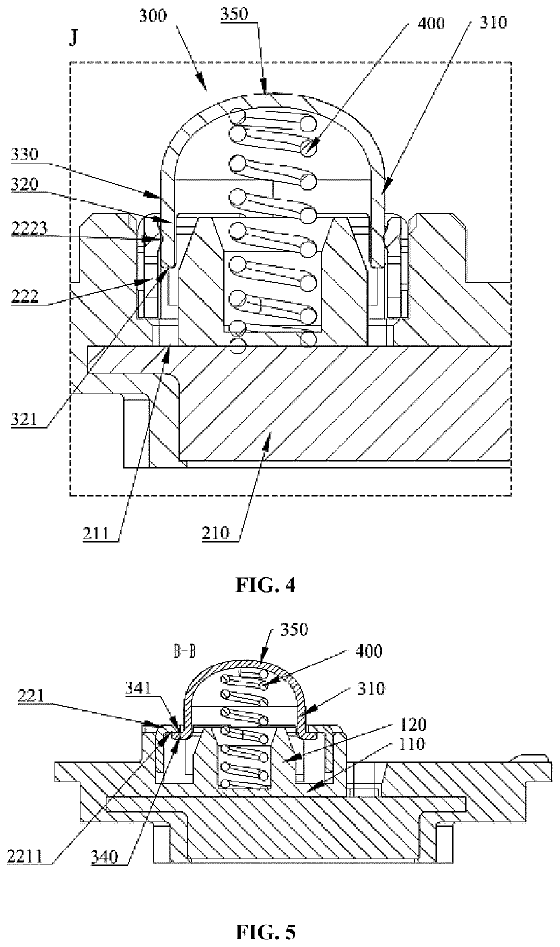

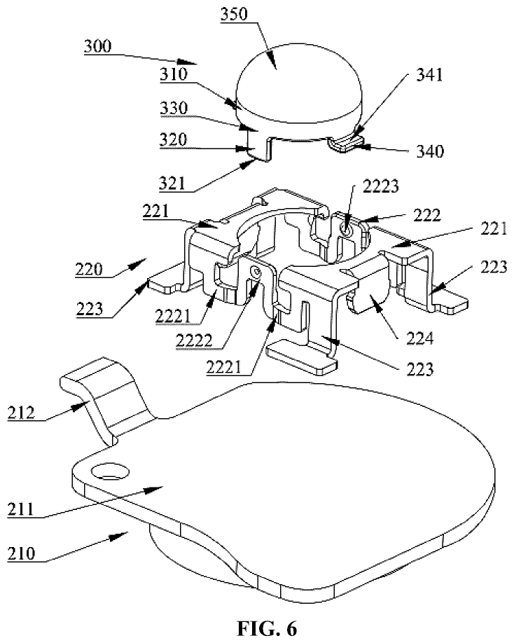

As shown in FIGS. 1 to 6, the embodiments provide a variable-impedance connector. The variable-impedance connector is connected in series in a control circuit and may provide signals with different resistance values in different states when the variable-impedance connector is conductive, thereby avoiding the generation of sparks due to sudden changes in resistance values.

The variable-impedance connector includes a support member 100, a fixed conductive assembly 200, and a movable conductive member 300. The support member 100 is prepared from an insulating material. The fixed conductive assembly 200 is fixed on the support member 100 and has a first fixed conductive portion 211, a second fixed conductive portion 2211, and a third fixed conductive portion 2223. The movable conductive member 300 is disposed on the support member 100, is at least partially capable of moving between the first fixed conductive portion 211 and the second fixed conductive portion 2211, and is capable of being connected to and conductive with the first fixed conductive portion 211 or the second fixed conductive portion 2211. The movable conductive member 300 is always connected to and conductive with the third fixed conductive portion 2223 in the process of moving between the first fixed conductive portion 211 and the second fixed conductive portion 2211. The contact area between the movable conductive member 300 and the first fixed conductive portion 211 is a first area, the contact area between the movable conductive member 300 and the second fixed conductive portion 2211 is a second area, the contact area between the movable conductive member 300 and the third fixed conductive portion 2223 is a third area, and the third area is smaller than the first area and smaller than the second area. In some embodiments, the first area and the second area are different.

It is to be noted that the fixed conductive assembly 200 and the movable conductive member 300 are both prepared from an electrically conductive material. For example, the fixed conductive assembly 200 and the movable conductive member 300 are both prepared from copper. In use, the variable-impedance connector is connected in series in the control circuit. Specifically, the path of the control circuit has two breakpoints, one of the two breakpoints is conductive with the movable conductive member 300, and the other of the two breakpoints is conductive with the fixed conductive assembly 200.

In the embodiments, the movable conductive member 300 and the fixed conductive assembly 200 have at least two connection states, and the entire variable-impedance connector remains conductive at all times during use. When the connector is damaged and disconnected, the connector may send a disconnection signal to a controller in time so that the controller may inform the maintenance personnel at the first time of the relevant situation and the maintenance personnel may check and maintain the connector as soon as possible, thereby improving the use experience. When the movable conductive member 300 is located between the first fixed conductive portion 211 and the second fixed conductive portion 2211, the movable conductive member 300 is still connected to and conductive with the third fixed conductive portion 2223, the contact area between the movable conductive member 300 and the third fixed conductive portion 2223 is small, and the impedance is large, thereby helping reduce power and consumption.

When the first area and the second area are different, the movable conductive member 300 and the fixed conductive assembly 200 have three connection states and may send three types of signals to the controller. When the connector is damaged and disconnected, the connector may send a disconnection signal to the controller in time, and the disconnection signal is different from the above three types of signals.

In some embodiments, the fixed conductive assembly 200 includes a first conductive member 210. The first fixed conductive portion 211 is disposed on the first conductive member 210. The movable conductive member 300 has a movable body 310 and a first movable conductive portion 321 disposed on the movable body 310. The movable body 310 is movably disposed on the support member 100. When the movable conductive member 300 abuts against the first conductive member 210, the first movable conductive portion 321 abuts against and is conductive with the first fixed conductive portion 211. Specifically, the first conductive member 210 is a block structure. The top surface of the first conductive member 210 forms the first fixed conductive portion 211. The movable body 310 is a cylinder-shaped structure. The lower end surface of the movable body 310 partially protrudes downward to form an elongated conductive arm 320. The lower end surface of the conductive arm 320 forms the first movable conductive portion 321. Through the above setting, when the lower end surface of the conductive arm 320 and the top surface of the first conductive member 210 are in contact with each other, the connection and conduction between the movable conductive member 300 and the first conductive member 210 can be achieved, and the limit between the movable conductive member 300 and the first conductive member 210 can also be achieved.

In some embodiments, the fixed conductive assembly 200 further includes a second conductive member 220 conductively connected to the first conductive member 210. The third fixed conductive portion 2223 is disposed on the second conductive member 220. The movable conductive member 300 has a third movable conductive portion 330. The contact area between the third movable conductive portion 330 and the third fixed conductive portion 2223 is the third area. The second conductive member 220 and the first conductive member 210 are disposed separately, thereby facilitating design, processing, and assembly. In the process where the movable conductive member 300 moves toward or away from the first conductive member 210, the third fixed conductive portion 2223 is in contact with and relatively slidingly fits with the third movable conductive portion 330 so that the movable conductive member 300, in the process of moving toward or away from the first conductive member 210, always remains connected to and conductive with the second conductive member 220.

In some embodiment, the second conductive member 220 has a second conductive body 221 and a conductive elastic portion 222 disposed on the second conductive body 221. The third fixed conductive portion 2223 is disposed on the conductive elastic portion 222 and is subjected to an elastic force of the conductive elastic portion 222 to keep a tendency to move toward the third movable conductive portion 330. Through the setting of the conductive elastic portion 222, even if the third fixed conductive portion 2223 is worn, the third fixed conductive portion 2223 remains in good contact with the third movable conductive portion 330.

Specifically, the conductive elastic portion 222 includes an elastic arm 2221 and an elastic seat 2222. One end of the elastic arm 2221 is connected to the second conductive body 221, and the other end of the elastic arm 2221 is connected to the elastic seat 2222. A boss protruding toward the third movable conductive portion 330 is formed through the stamped piece-shaped elastic seat 2222. The sidewall of the boss facing the third movable conductive portion 330 forms the third fixed conductive portion 2223. Two second conductive bodies 221 are disposed, and two conductive elastic portions 222 are disposed. The two conductive elastic portions 222 are disposed in parallel and spaced apart between the two second conductive bodies 221. The two second conductive bodies 221 and the two conductive elastic portions 222 enclose a frame structure, and the movable conductive member 300 moves in the frame structure. Further, the elastic arm 2221 is U-shaped. Two elastic arms 2221 are disposed, and the openings of the two elastic arms 2221 face upward. The elastic seat 2222 is disposed between the two elastic arms 2221. Two ends of the elastic seat 2222 are connected to two end portions of the two elastic arms 2221 that face one another, respectively, and two end portions of the two elastic arms 2221 that face in opposite directions are connected to the two second conductive bodies 221, respectively. The elastic arm 2221, the elastic seat 2222, and the second conductive body 221 are integrally molded, thereby ensuring the stability and reliability of the connection.

The movable body 310 is a cylinder-shaped structure. The lower end surface of the movable body 310 partially protrudes downward to form an elongated conductive arm 320. The movable body 310 and the outer sidewall of the conductive arm 320 form the third movable conductive portion 330. The lower end surface of the conductive arm 320 serves as the first movable conductive portion 321, and the outer sidewall is synergistic with the movable body 310 to serve as the third movable conductive portion 330, thereby achieving a compact structure and simplifying the overall structure.

To improve the safety in use, further, the second fixed conductive portion 2211 is disposed on the second conductive member 220, and the movable conductive member 300 has a second movable conductive portion 341. When the movable conductive member 300 is in a state of being away from the first conductive member 210, the second fixed conductive portion 2211 is connected to and conductive with the second movable conductive portion 341. Through the above setting, the movable conductive member 300 may always remain connected to and conductive with the fixed conductive assembly 200, thereby reducing the probability of the generation of sparks between the movable conductive member 300 and the fixed conductive assembly 200 when the movable conductive member 300 is in different locations.

The second conductive body 221 is a sheet-shaped structure. The bottom surface of the second conductive body 221 forms the second fixed conductive portion 2211. The movable conductive member 300 includes a cylinder-shaped movable body 310. The lower end surface of the movable body 310 is partially folded outward to form a limit arm 340. The upper side surface of the limit arm 340 forms the second movable conductive portion 341. The limit arm 340 abuts against the second conductive body 221 when the movable conductive member 300 is in a state of being away from the first conductive member 210. Through the above setting, the second conductive body 221 not only plays the role of limiting but also plays the role of conducting with the second movable conductive portion 341.

In the embodiments, the three connection states between the movable conductive member 300 and the fixed conductive assembly 200 are as follows: When the movable conductive member 300 is away from the first conductive member 210, the second fixed conductive portion 2211 is connected to and conductive with the second movable conductive portion 341, the first movable conductive portion 321 is not connected to and is not conductive with the first fixed conductive portion 211, and the third fixed conductive portion 2223 is connected to and conductive with the third movable conductive portion 330. When the movable conductive member 300 moves toward the first conductive member 210, the first movable conductive portion 321 is not connected to and is not conductive with the first fixed conductive portion 211, the second fixed conductive portion 2211 is not connected to and is not conductive with the second movable conductive portion 341, and the third fixed conductive portion 2223 is connected to and conductive with the third movable conductive portion 330. When the movable conductive member 300 abuts against the first conductive member 210, the first movable conductive portion 321 is connected to and conductive with the first fixed conductive portion 211, the second fixed conductive portion 2211 is not connected to and is not conductive with the second movable conductive portion 341, and the third fixed conductive portion 2223 is connected to and conductive with the third movable conductive portion 330. In other words, in the three connection states between the movable conductive member 300 and the fixed conductive assembly 200, the third fixed conductive portion 2223 is always connected to and conductive with the third movable conductive portion 330.

To ensure the stability of the connection and conduction between the second conductive member 220 and the first conductive member 210, in some embodiments, the second conductive member 220 includes a second conductive body 221 and a conductive connecting sheet 223 disposed on the second conductive body 221, and the first conductive member 210 is a block structure. The top surface of the first conductive member 210 is welded to the conductive connecting sheet 223. Further, the second conductive member 220 has at least four conductive connecting sheets 223. The four conductive connecting sheets 223 are dispersed on the circumferential side of the second conductive body 221 to improve the force balance.

The second conductive member 220 is detachably connected to the support member 100. Before welding, the second conductive member 220 and the support member 100 are connected so that both the second conductive member 220 and the first conductive member 210 are fixed relative to the support member 100, thereby facilitating the connection between the second conductive member 220 and the first conductive member 210 and improving welding efficiency and welding precision.

In the embodiments, the support member 100 is provided with a slot, and the second conductive member 220 further includes a snap-in sheet 224 disposed on the second conductive body 221. The snap-in sheet 224 is snapped in the slot. Through the above setting, the positions of the second conductive member 220 and the support member 100 are unchanged during welding, thereby ensuring welding precision. Moreover, the snap-in structure is simple, thereby facilitating assembly and improving assembly efficiency.

Further, the second conductive member 220 has at least two snap-in sheets 224. The two snap-in sheets 224 are disposed on both sides of the second conductive body 221, thereby improving the force balance between the second conductive member 220 and the support member 100.

The support member 100 is wrapped around the outer periphery of the first conductive member 210 by an injection molding process. The first conductive member 210 is a cylindrical structure. The first conductive member 210 has a stop arm 212 extending in a direction away from the axis of the first conductive member 210 on the circumference of the first conductive member 210 to stop the first conductive member 210 from rotating relative to the support member 100.

In some embodiments, the movable conductive member 300 is subjected to an elastic force to enable the movable conductive member 300 to be at least partially away from the first fixed conductive portion 211. For example, the movable conductive member 300 is subjected to an elastic force to enable the first movable conductive portion 321 on the movable conductive member 300 to be away from the first fixed conductive portion 211. The variable-impedance connector includes an elastic member 400. The elastic member 400 is disposed between the support member 100 and the movable conductive member 300 and is used for driving the movable conductive member 300 away from the first fixed conductive portion 210. With the setting of the elastic member 400, the force applied to the movable conductive member 300 may be adjusted to adapt to different application scenarios, and different force requirements may be met by only replacing the elastic member 400.

For the position where the elastic member is mounted, in some embodiments, the support member 100 includes a support seat 110 and a guide ring 120, the movable conductive member 300 includes a cylinder-shaped movable body 310 and a blocking plate 350 disposed on one end of the movable body 310, the guide ring 120 is located in the movable body 310 to allow the movable conductive member 300 to move toward or away from the support seat 110 along the guide ring 120, the elastic member 400 is a spring, a portion of the spring is located in the guide ring 120, one end of the spring abuts against the support seat 110, and the other end of the spring abuts against the blocking plate 350. The guide ring 120 may serve as a guide track for the movable conductive member 300 and also serve as a receiving structure for the spring to prevent the spring from disengagement.

In use, a press structure presses the blocking plate 350 to push the entire movable conductive member 300 toward the first conductive member 210. In some embodiments, the blocking plate 350 is hemispherical and protrudes in a direction away from the movable body 310. The above structure allows the blocking plate 350 to be in contact with the press structure with a balanced force, thereby reducing the requirement for alignment precision between the blocking plate 350 and the press structure and reducing costs.

In other embodiments, the elastic member 400 may not be disposed, and the elastic force is provided by the movable conductive member 300. Specifically, the movable conductive member 300 may include a strip-shaped elastic portion and a docking member. One end of the elastic portion is fixed to the support member 100, and the other end of the elastic portion is connected to the docking member. The docking member is capable of moving relative to the support member 100. The first movable conductive portion 321, the second movable conductive portion 341, and the third movable conductive portion 330 are disposed on the docking member.

In some embodiments, at least two fixed conductive assemblies 200 and at least two movable conductive members 300 are mounted on the support member 100, and the at least two fixed conductive assemblies 200 and the at least two movable conductive members 300 correspondingly cooperate. For example, three fixed conductive assemblies 200 and three movable conductive members 300 are mounted on the support member 100, and the three fixed conductive assemblies 200 and the three movable conductive members 300 correspondingly cooperate.

Apparently, the preceding embodiments of the present disclosure are merely examples for the purpose of clearly illustrating the present disclosure and are not intended to limit implementations of the present disclosure. Those of ordinary skill in the art can make changes or alterations of different forms based on the above description. All implementations cannot be and do not need to be exhausted herein. Any modifications, equivalent substitutions, and improvements made within the spirit and principle of the present disclosure fall within the scope of the claims of the present disclosure.

What is claimed is:

1. A variable-impedance connector, comprising
a support member, prepared from an insulating material;
a fixed conductive assembly, fixed on the support member and having a first fixed conductive portion, a second fixed conductive portion, and a third fixed conductive portion; and
a movable conductive member, disposed on the support member, at least partially capable of moving between the first fixed conductive portion and the second fixed conductive portion, and capable of being connected to and conductive with the first fixed conductive portion or the second fixed conductive portion; wherein the movable conductive member is always connected to and conductive with the third fixed conductive portion in the process of moving between the first fixed conductive portion and the second fixed conductive portion;
wherein a contact area between the movable conductive member and the first fixed conductive portion is a first area, a contact area between the movable conductive member and the second fixed conductive portion is a second area, a contact area between the movable conductive member and the third fixed conductive portion is a third area, and the third area is smaller than the first area and smaller than the second area.

2. The variable-impedance connector according to claim 1, wherein the fixed conductive assembly comprises a first conductive member, the first fixed conductive portion is disposed on the first conductive member, the movable conductive member has a movable body and a first movable conductive portion disposed on the movable body, and the movable body is movably disposed on the support member; when the movable conductive member abuts against the first conductive member, the first movable conductive portion abuts against and is conductive with the first fixed conductive portion.

3. The variable-impedance connector according to claim 2, wherein the first conductive member is a block structure, a top surface of the first conductive member forms the first fixed conductive portion, the movable body is a cylinder-shaped structure, a lower end surface of the movable body partially protrudes downward to form an elongated conductive arm, and a lower end surface of the conductive arm forms the first movable conductive portion; or
the support member is wrapped around an outer periphery of the first conductive member by an injection molding process, the first conductive member is a cylindrical structure, and the first conductive member has a stop arm extending in a direction away from an axis of the first conductive member on a circumference of the first conductive member to stop the first conductive member from rotating relative to the support member.

4. The variable-impedance connector according to claim 2, wherein the fixed conductive assembly further comprises a second conductive member conductively connected to the first conductive member, the third fixed conductive portion is disposed on the second conductive member, the movable conductive member has a third movable conductive portion, and a contact area between the third movable conductive portion and the third fixed conductive portion is the third area.

5. The variable-impedance connector according to claim 4, wherein the third movable conductive portion slidingly fits with the third fixed conductive portion.

6. The variable-impedance connector according to claim 5, wherein the second conductive member has a second conductive body and a conductive elastic portion disposed on the second conductive body, and the third fixed conductive portion is disposed on the conductive elastic portion and is subjected to an elastic force of the conductive elastic portion to keep a tendency to move toward the third movable conductive portion.

7. The variable-impedance connector according to claim 6, wherein the conductive elastic portion comprises an elastic arm and an elastic seat, an end of the elastic arm is connected to the second conductive body, an other end of the elastic arm is connected to the elastic seat, a boss protruding toward the third movable conductive portion is formed by stamping the sheet-shaped elastic seat, and a sidewall of the boss facing the third movable conductive portion forms the third fixed conductive portion.

8. The variable-impedance connector according to claim 5, wherein the movable body is a cylinder-shaped structure, a lower end surface of the movable body partially protrudes downward to form an elongated conductive arm, and the movable body and an outer sidewall of the conductive arm form the third movable conductive portion.

9. The variable-impedance connector according to claim 6, wherein the second fixed conductive portion is disposed on the second conductive member, and the movable conductive member has a second movable conductive portion; when the movable conductive member is in a state of being away from the first conductive member, the second fixed conductive portion is connected to and conductive with the second movable conductive portion.

10. The variable-impedance connector according to claim 9, wherein the second conductive body is a sheet-shaped structure, a bottom surface of the second conductive body forms the second fixed conductive portion, the movable conductive member comprises a cylinder-shaped movable body, a lower end surface of the movable body is partially folded outward to form a limit arm, an upper side surface of the limit arm forms the second movable conductive portion, and the limit arm abuts against the second conductive body when the movable conductive member is in a state of being away from the first conductive member.

11. The variable-impedance connector according to claim 4, wherein the second conductive member comprises a second conductive body and a conductive connecting sheet disposed on the second conductive body, the first conductive member is a block structure, and a top surface of the first conductive member is welded to the conductive connecting sheet.

12. The variable-impedance connector according to claim 11, wherein the second conductive member has at least four conductive connecting sheets, and the four conductive connecting sheets are dispersed on a circumferential side of the second conductive body.

13. The variable-impedance connector according to claim 4, wherein the second conductive member is detachably connected to the support member.

14. The variable-impedance connector according to claim 13, wherein the support member is provided with a slot, the second conductive member further comprises a snap-in sheet disposed on the second conductive body, and the snap-in sheet is snapped in the slot.

15. The variable-impedance connector according to claim 1, wherein the movable conductive member is subjected to an elastic force to enable the movable conductive member to be at least partially away from the first fixed conductive portion.

16. The variable-impedance connector according to claim 15, wherein the variable-impedance connector comprises an elastic member, and the elastic member is disposed between the support member and the movable conductive member and is used for driving the movable conductive member away from the first fixed conductive portion.

17. The variable-impedance connector according to claim 16, wherein the support member comprises a support seat and a guide ring, the movable conductive member comprises the cylinder-shaped movable body and a blocking plate disposed on an end of the movable body, the guide ring is located in the movable body, the elastic member is a spring, a portion of the spring is located in the guide ring, an end of the spring abuts against the support seat, and an other end of the spring abuts against the blocking plate.

18. The variable-impedance connector according to claim 17, wherein the blocking plate is hemispherical and protrudes in a direction away from the movable body.

19. The variable-impedance connector according to claim 2, wherein the movable conductive member is subjected to an elastic force to enable the movable conductive member to be at least partially away from the first fixed conductive portion.

20. The variable-impedance connector according to claim 3, wherein the movable conductive member is subjected to an elastic force to enable the movable conductive member to be at least partially away from the first fixed conductive portion.
